(19) United States
(12) Patent Application Publication
(10) Pub. No.: US 2010/0075096 A1
(43) Pub. Date: Mar. 25, 2010

(54) ROLL

(75) Inventor: Urban Widlund, Pixbo (SE)

Correspondence Address: YOUNG & THOMPSON, 209 Madison Street, Suite 500, Alexandria, VA, 22314, US

(73) Assignee: SCA HYGIENE PRODUCTS AB, GOTEBORG (SE)

(21) Appl. No.: 12/517,243

(22) PCT Filed: Dec. 8, 2006
(86) PCT No.: PCT/SE06/01400

§ 371 Date: Jun. 2, 2009

(51) Int. Cl. B32B 3/04

(52) U.S. Cl. 428/57

(57) ABSTRACT

The invention relates to a roll of material sheets, which material sheets have a longitudinal direction and a transverse direction, wherein the roll includes discrete material sheets. The material sheets are folded at least once in the longitudinal direction, which direction corresponds to the winding direction of the roll. The material sheets being interlinked in such a way that, when a first material sheet is extracted, a predetermined part of a subsequent material sheet is fed out.

### TECHNICAL FIELD

This invention relates to a roll of material sheets folded at least once in the longitudinal direction, which direction corresponds to the winding direction of the roll. The material sheets being interlinked in such a way that, when a first material sheet is extracted, a predetermined part of a subsequent material sheet is fed out.

### BACKGROUND ART

A common solution for dispensing material for drying or wiping is to provide a roll of wound paper or tissue in a suitable dispenser. Rolls of this type are usually of the centrefeed type, wherein a web of paper is removed from the centre of the roll. However, the problems listed below will also apply to rolls where a web is dispensed from the outer periphery of the roll, sometimes referred to as “perifeed” rolls. When placed in a dispenser, a user will withdraw a desired length of paper and tear it off using a serrated edge provided on the dispenser. A problem with this solution is that it may be difficult to estimate the length of the withdrawn web and that the serrated edge tends to result in an uneven edge. In addition the wound web will be dispensed in a twisted, spiral form that must be straightened before used. To overcome at least some of these problems, the paper web may be perforated at regular intervals. This may at least partly alleviate the problem of an unsightly, uneven edge provided that a perforated line is present near the portion that the user wishes to tear. However, the problem of the twisted, spiral web is not resolved by perforating the paper web.

It is an object of the present invention to solve the above problems by providing an improved centrefeed or perifeed roll for use in a dispenser arrangement for dispensing material from a wound roll.

### DISCLOSURE OF INVENTION

The above objects are achieved by means of a roll of material sheets according to claim 1 and its dependent claims.

In the subsequent text the terms “longitudinal” and “transverse” are used to define the relative position of a material sheet relative to the direction of feed of the sheet. The direction of feed coincides with the longitudinal axis of the material sheets. These terms are not necessarily related to the relative size of the side edges of a material sheet. Similarly, the terms “preceding” “and “subsequent” or “front” and “rear” are used to define the relative position of a material sheet in relation to adjacent sheets in relation to the direction of feed of the sheets.

A roll made from an assembled web of discrete sheets arranged according to any of the embodiments described below may be a centrefeed roll, whereby the material sheets are extracted from the centre of the roll, or a peripheral feed roll, sometimes termed “perifeed” roll, whereby the material sheets are extracted from the outer periphery of the roll.

According to a preferred embodiment, the invention relates to a roll of material sheets, which material sheets have a longitudinal direction and a transverse direction. The roll comprises discrete material sheets, which material sheets are folded at least once in the longitudinal direction, which direction corresponds to the winding direction of the roll. The assembled web may comprise a single line of material sheets cut from a continuous length of material. Alternatively two single lines of material sheets may be interposed on each other to form a single web. A longitudinal fold line is preferably, but not necessarily arranged so that the material sheets are folded in half. The material sheets are preferably interlinked in such a way that, when a first material sheet is extracted, a predetermined part of a subsequent material sheet is fed out.

According to a further embodiment, the material sheets may be folded twice in the longitudinal direction of the said material sheets. Preferably, the distance between the parallel fold lines is at least half the width of a sheet in the transverse direction. This type of folding arrangement is sometimes referred to as a C-fold and is preferably, but not necessarily, performed when the material sheets are placed in an overlapping relationship.

According to a first alternative embodiment, the interlinking may be achieved by at least partially overlapping adjacent end portions of the material sheets. The material sheets may be interlinked by a fixed overlap of at least 25% of the length of an unfolded material sheet in its longitudinal direction. The overlap may be up to 50% of the length of an unfolded material sheet in the longitudinal direction. This overlap may be constant, but can also be variable depending on predetermined parameters as described below.

For a perifeed roll, the friction between adjacent material sheets may be substantially constant from the outer periphery to the centre of the roll, as subsequent material sheets are continuously exposed by the removal of preceding material sheets. In this case, the overlap may be substantially constant. The overlap may be selected in the range 25-50% of the length of an unfolded material sheet in its longitudinal direction, depending on the properties of the material sheets. Examples of such properties may be the surface structure or the physical size of the material sheets.

According to a second alternative embodiment, the degree of overlap may be arranged to be proportional to the radius of the roll, so that the overlap varies from the centre of the roll to the outer periphery of the roll. For instance, for a centrefeed roll, the friction between adjacent material sheets may be larger near the centre of a roll, due to a relatively higher roll density of the material sheets and a relatively restricted central opening available for withdrawing sheets through the roll. As sheets are withdrawn, the roll density may be reduced and the opening at the centre of the roll increases, so that the friction forces between adjacent material sheets are reduced. In this case, the degree of overlap may be at least 25% of the length of an unfolded material sheet in its longitudinal direction at the centre of the roll, wherein the overlap increases in the direction of the outer periphery of the roll. The degree of overlap may be increased up to 50% of the length of an unfolded material sheet in the longitudinal direction at the outer periphery of a full roll.

For a centrefeed roll, the friction between adjacent material sheets may be larger near the outer periphery of a roll, due to the roll weight requiring a relatively higher force for withdrawing each sheet when the roll is first started. As sheets are withdrawn, the roll weight is reduced and less force is required for withdrawing sheets. Hence the friction forces between adjacent material sheets may be reduced towards the centre of the roll. In this case, the degree of overlap may be up to 50% of the length of an unfolded material sheet in its longitudinal direction at the outer periphery of a full roll, wherein the overlap decreases in the direction of the centre of the roll. The degree of overlap may be decreased to 25% of the length of an unfolded material sheet in the longitudinal direction at the centre of the roll.

Alternatively, by controlling the roll density of a roll, in particular of a perifeed roll, during winding, the friction between adjacent material sheets may be kept substantially constant from the outer periphery to the centre of the roll. In such cases, a substantially constant overlap may be selected in the range 25-50% of the length of an unfolded material sheet in its longitudinal direction, depending on the properties of the material sheets.

According to a third alternative embodiment of the invention the overlap between adjacent material sheets forming a roll may be formed by placing two parallel lines of individual material sheets on top of each other. As opposed to the first alternative embodiment, each alternate sheet of an assembled web is placed with its transverse rear portion arranged on top of a transverse front portion of a subsequent sheet, and with its transverse front portion on top of the transverse rear portion of a preceding sheet throughout the said web. This may be achieved by cutting a continuous web into a first line of sheets and then placing a cut, second line of sheets on top of said first line of sheets. Each line of sheets of the respective first and second line may be arranged end-to-end or at a predetermined fixed or variable distance between opposing ends of consecutive material sheets.

The interlinking may be achieved by at least partially overlapping adjacent ends of the material sheets. The material sheets may be interlinked by an overlap of at least 25% of the length of an unfolded material sheet in its longitudinal direction. An overlap between 25% and 50% will require a separation of the individual sheets in each line of sheets prior to, or subsequent to, the assembly of the first and second lines of sheets. The overlap may be up to and including 50% of the length of an unfolded material sheet in the longitudinal direction. A 50% overlap merely requires indexing of the cut second line of sheets in the longitudinal direction prior to placing it on top of the cut first line of sheets. The overlap may be constant, but can also be variable depending on predetermined parameters.

The first and second lines of sheets may be placed on top of each other with their respective side edges coinciding in a vertical plane, that is, with a 100% transverse overlap. The transverse overlap may be selected between 30% and 100% of the transverse width of the material sheets.

According to a first example of the third alternative embodiment, the degree of longitudinal overlap is 50% of the length of an unfolded material sheet in its longitudinal direction. The transverse overlap may in this example be 100% of the transverse width of the material sheets.

The partially overlapping first and second lines of material sheets may be folded at least once in the longitudinal direction to form an assembled web, wherein the longitudinal direction corresponds to the winding direction of the material sheets forming the roll. Such a longitudinal fold line is preferably, but not necessarily arranged so that the material sheets are folded in half. The assembled web may then be wound to form said roll of material sheets.

According to a second example of the third alternative embodiment, the degree of overlap is 50% of the length of an unfolded material sheet in its longitudinal direction. The transverse overlap may in this example be 50% of the transverse width of the material sheets.

Preferably, the partially overlapping material sheets may be folded twice in the longitudinal direction of the said material sheets. The distance between the parallel fold lines may be at least half the width of each sheet in the transverse direction. The assembled web can be achieved by folding the outer, non-overlapping edge of the lower line of material sheets inwards over and fully covering the overlap. Subsequently, the outer, non-overlapping edge of the upper line of material sheets inwards over and fully covering the first folded edge and the overlap. Alternatively the assembled web is created by simultaneously folding the outer edge of the lower line of material sheets upwards and inwards, and the outer edge of the upper line of material sheets downwards and inwards This type of folding arrangement creates an assembled web comprising consecutive partially overlapping pairs of substantially V-shaped, opposed and interleaved material sheets.

The same effect, using partial overlap in the transverse direction may be achieved at other degrees of overlap. For instance, with a transverse overlap of ⅓ of the transverse width, the sheets on either side of the overlap may be folded in half towards to create an assembled web. Alternatively, with a transverse overlap of ⅔ of the transverse width, the sheets on either side of the overlap may be folded along a longitudinal fold line located at approximately ⅓ of the width from the outer edges of the respective of the first and second line of sheets to cover a part of the overlap and create an assembled web.

The examples described above for the third alternative embodiment may also apply to examples using a variable overlap in the longitudinal direction.

The assembled web of longitudinally and transversely overlapping material sheet may then be wound in the same way as described above for a single line of material sheets in order to form a roll.

In addition to the overlap, adjacent material sheets may be interlinked by one or more alternative arrangements in order to achieve a desired friction between at least predetermined parts of the contacting surfaces of said material sheets. By modifying the friction between adjacent surfaces it is possible to ensure that a first material sheet withdrawn from a dispenser will feed out a predetermined portion of a subsequent material sheet. The amount of friction modification is dependent on the quality and surface structure of the material sheets used. For sheets having a relatively rough surface structure the friction resulting from the overlapped and folded relationship between adjacent sheets may be sufficient. In this case, varying the amount of overlap may be sufficient to achieve the desired result. On the other hand, for material sheets having a relatively smooth surface structure a friction enhancing process and/or arrangement may be required to ensure that a portion of a subsequent material sheet is fed out by a preceding material sheet.

One alternative way of modifying the friction between overlapping sections of material sheets may be an embossing on at least a portion of the overlap. Such an embossing may be carried out by passing an assembled web of pre-cut and partially overlapping material sheets through a nip between a pair of cylindrical rolls. The rolls may be arranged to apply a desired amount of pressure onto at least a portion of the overlapping sections and/or to apply pressure over a predetermined surface area of each overlapping section. One or both rolls may be patterned in order to emboss the compressed portions to a predetermined degree.

According to a further alternative way of modifying the friction, the material sheets may be interlinked by a friction enhancing coating applied onto at least a portion of the overlapping sections between adjacent sheets. A coating of this type may be applied to at least a portion of one or both ends of each sheet in an assembled web of material sheets. The coating may be applied by a single roller or a pair of rollers, or by spraying. Coatings of this type may modify the surface friction of at least one of the surfaces in an overlapping section. The coating may also create a brittle bonding between contacting surfaces.

According to a similar alternative way of modifying the friction, the material sheets may be interlinked by a rubber emulsion or an adhesive on at least a portion of the overlap between adjacent sheets. Suitable adhesives may include liquid, curable adhesives, wax based hot-melt adhesives, friction hot-melt adhesives, adhesives with low adhesion and high cohesion, or a weak adhesive applied as multiple spots, such as starch or polyvinyl alcohol. Such adhesives may be applied in the same way as the coatings described above. Such a coating or adhesive may be applied prior to, preferably immediately prior to, the sheets being displaced into their overlapping positions.

According to a further alternative embodiment, the overlap may be combined with an alternative way of interlinking the material sheets. Prior to being placed in an overlapping relationship, adjacent ends of sheets to be overlapped are folded once along a fold line in the transverse direction of the respective sheet. Opposing ends of each sheet are folded in opposite directions so that each material sheet will be substantially Z-shaped. The distance between a transverse edge of the sheet and an adjacent transverse fold line may be between 5-25% of the total length of an unfolded material sheet. The adjacent material sheets are then interlinked in such a way that each folded end portion encloses the adjacent folded end portion. In this way, the end portions of adjacent material sheets will be overlapping and the folded end portions of each pair of said sheets may hook into the other. The transverse folding is preferably performed before a subsequent longitudinal folding of the assembled overlapping material sheets.

Individual sheets in the line or lines of material sheets cut from a continuous web may be separated by a straight, transverse cut at right angles to the longitudinal axis of the respective line of sheets. According to an alternative example, the transverse cut may have the shape of a curve having at least one apex, where the apex forms a leading or trailing edge of each material sheet in the line. The apex may preferably, but not necessarily, coincide with a fold line and the curve may preferably, but not necessarily, be symmetrical about an axis coinciding with the said fold line in the plane of the material sheet.

For example, for single line of material sheets placed in a constant or variable overlapping relationship the cut may have an approximate sinusoidal shape, with a single apex coinciding with a central fold line. Alternatively, if the assembled web has two fold lines, such as a C- or Z-fold, the cut may comprise a substantially sinusoidal curve with an apex coinciding with each fold line. The shape of the cut and the location one the at least one apex may also be applied to assembled webs comprising two lines of material sheets. The shape of the curve is not limited to sinusoidal curves, but may be given any suitable shape having an apex at leading edge of each material sheet.

Advantages of the transverse cut are that it makes the assembled web easier to handle during the production stage and that it provides an improved, easy to grasp portion when a subsequent material sheet is pulled out and presented to a user.

Non-limiting examples of suitable materials for sheets for this purpose are suitable tissue products, such as wet crêpe dry crêpe or through-air-dried (TAD) materials, which products contain mostly paper pulp. The material sheets may also be made from a suitable type of non-woven or equivalent wiping material. The non-woven materials may be spunbond, thermobond, chemically bonded, spunlaced, spunlaid, carded, air laid or entangled non-wovens. The non-woven materials may comprise suitable natural or manmade fibres, containing cotton or rayon, polypropylene (PP), polyethylene (PE), polyether sulfone (PES), polyethylene terephthalate (PET), polyester, polyamide, bi-component fibres (Bico) or pulp fibres.

A dispenser for use with a roll according to the invention may be provided with a dispensing opening through which the material sheets are dispensed. Because a roll according to the invention comprises individual material sheets there is no need to provide the dispenser with tear means adjacent the dispensing opening. However, the dispensing opening can be provided with a serrated edge or similar, in order to allow the dispenser to be used for rolls comprising either separate sheets or a continuous web.

### BRIEF DESCRIPTION OF DRAWINGS

In the following text, the invention will be described in detail with reference to the attached drawings. These schematic drawings are used for illustration only and do not in any way limit the scope of the invention. In the drawings:

FIG. 1 shows a lower perspective view of a dispenser provided with a roll of discrete material sheets according the invention;

FIG. 2 shows a plan view of a first part of a process for making a roll of material sheets according to a first embodiment of the invention;

FIG. 3A shows a plan view of a folding process occurring subsequent to the process of FIG. 2;

FIG. 3B shows a plan view of an alternative folding process occurring subsequent to the process of FIG. 2;

FIG. 4A shows a side view of a continuous web of material sheets assembled as shown in FIGS. 2 and 3A;

FIG. 4B shows a side view of a continuous web of material sheets assembled as shown in FIGS. 2 and 3B;

FIG. 5 shows an alternative longitudinal folding procedure occurring subsequent to the process of FIG. 2.

FIG. 6 shows a schematic perspective view of the first part of a process for making a roll of material sheets according to a second embodiment of the invention.

FIGS. 7A-B show a plan view of a first part of a process for making a roll of material sheets according to first example of a second preferred embodiment of the invention;

FIGS. 8A-B show a plan view of a first part of a process for making a roll of material sheets according to second example of a second preferred embodiment of the invention; and

FIGS. 9A-B show a plan view of a part of a process for making a roll of material sheets separated by a curved transverse cut.

### EMBODIMENTS OF THE INVENTION

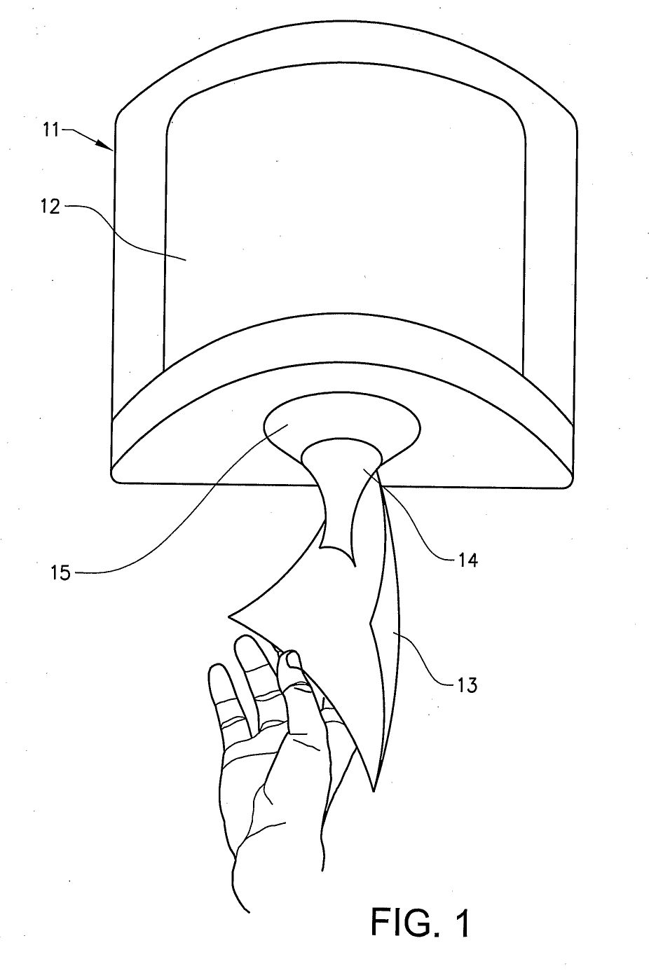

FIG. 1 shows a lower perspective view of a dispenser 11 provided with a roll 12 of discrete material sheets 13. The roll 12 comprises discrete material sheets assembled, folded and wound into a roll in accordance with the invention. The discrete material sheets are interlinked in such a way that, when a first material sheet 13 is extracted by a user, a predetermined part of a subsequent material sheet 14 is pulled out of the dispenser 11 by the first material sheet 13. The dispenser 1 is provided with a dispensing opening 15 through which the material sheets are dispensed. The dispensing opening can be provided with a serrated edge (not shown) or similar, in order to allow the dispenser to be used for rolls comprising a continuous web.

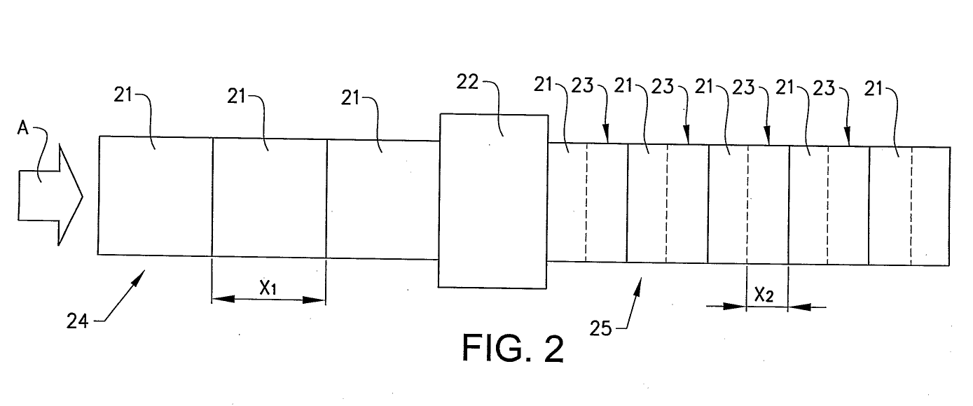

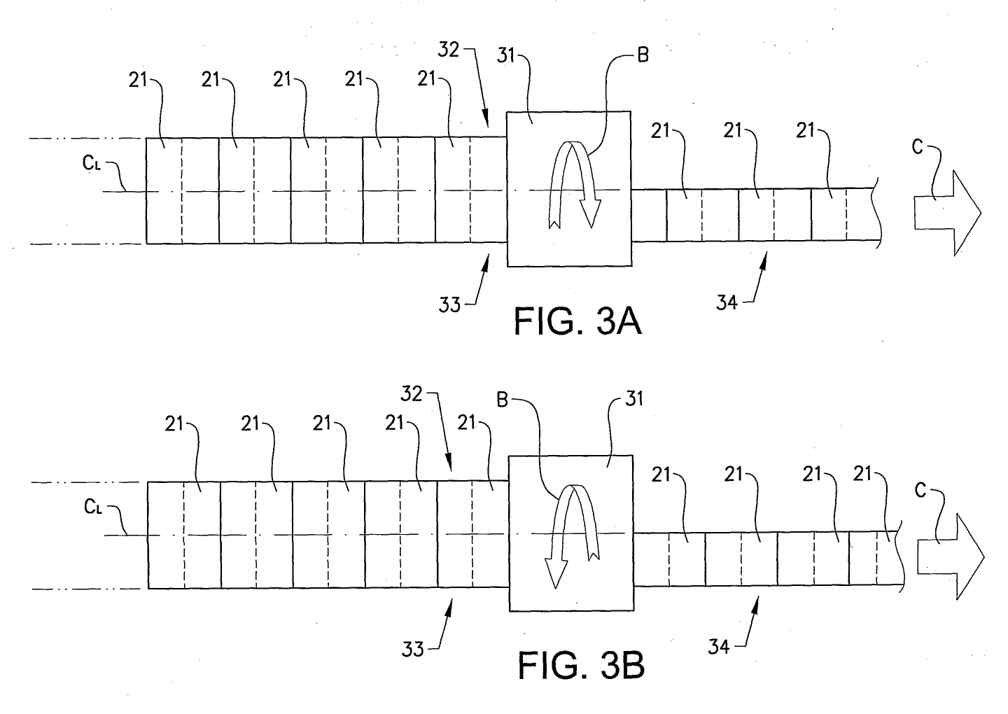

FIG. 2 shows a plan view of a first part of a process for making a roll of material sheets according to a first embodiment of the invention. The material sheets used in the process have been pre-cut from a continuous web of material (not shown) in a first step. The resulting material sheets have a longitudinal direction and a transverse direction. The process involves feeding an assembled web of discrete material sheets 21, placed end-to-end in their longitudinal direction, through an apparatus 22 arranged for displacing the discrete material sheets 21 so that overlap 23 is created by adjacent material sheets in their longitudinal direction. This is achieved by controlling the relative speed of a first and a second conveyor 24, 25. The apparatus 22 for displacing the discrete material sheets 21 is provided with a device (not shown) for controlling the vertical position of the front edge of a material sheet relative to the rear edge of a preceding sheet is provided at the location where the material sheets are passed from the first to the second conveyor. In the example shown, the length X₁ of the overlap 23 is ⅓ of the length X₂ of an unfolded material sheet 21. The overlap 23 can be increased by slowing down the second conveyor 25 to a predetermined speed relative to the first conveyor 24, and vice versa. As can be seen from the example in FIG. 2, the front portion of each material sheet is positioned on top of a preceding sheet. Subsequently, the assembled web of overlapping material sheets 21 is fed through an apparatus 31 arranged to fold the sheets 21 along a fold line coinciding with the longitudinal centreline C_{L} of the material sheets 21, as shown in FIG. 3A. According to the example shown in FIG. 3A, the left hand side 32 of each material sheet is displaced upwards and folded over the right hand side 33 of the material sheet 21, as indicated by the arrow B, as seen in the direction of feed, as indicated by the arrow C, of the assembled web of material sheets 21. The overlapping and folded material sheets 21 can then be fed as a continuous assembled web 34 between opposing rollers and/or conveyors (not shown) and is subsequently subjected to a winding operation.

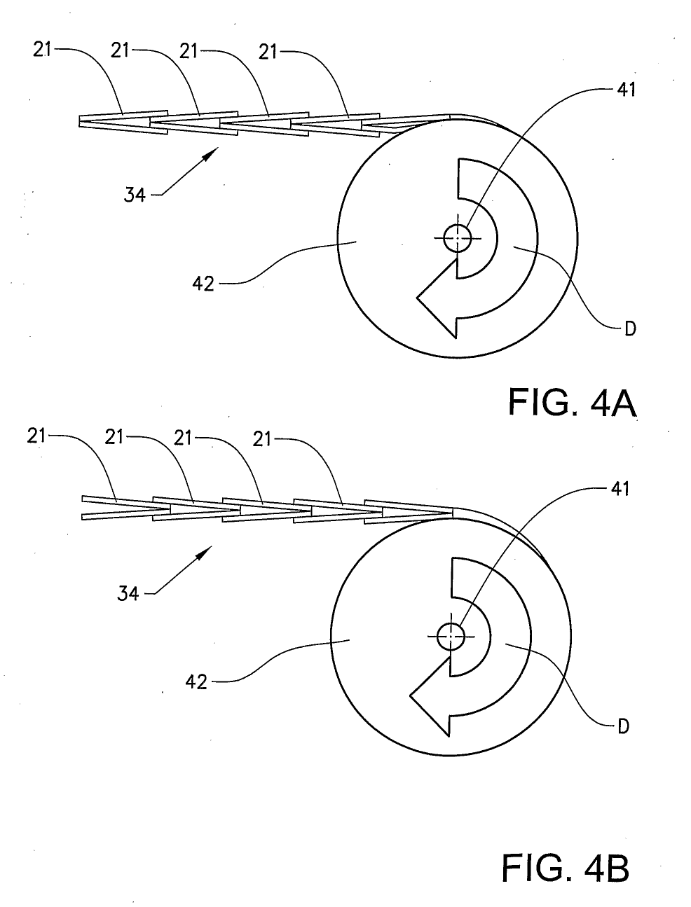

FIG. 4A shows a side view of a continuous web 34 assembled from an assembled web of overlapping and folded material sheets 21 as described in FIGS. 2 and 3A above. A conveyor supporting the assembled web of material sheets has been removed for clarity. The assembled web of material sheets 21 are then attached to a mandrel 41 and subjected to a winding operation, as shown in FIG. 4A. The assembled, discrete material sheets 21 are wound in the clockwise direction, as indicated by the arrow D, to form a roll 42.

According to an alternative first embodiment, the front portion of each material sheet is positioned on top of a preceding sheet in the same way as described in connection with FIG. 2 above. The subsequent longitudinal folding procedure is similar to the procedure described in FIG. 3A above. As shown in FIG. 3B, the assembled web of overlapping material sheets 21 is fed through an apparatus 31 arranged to fold the sheets 21 along a fold line coinciding with the longitudinal centreline C_{L} of the material sheets 21. The left hand side 32 of each material sheet is displaced downwards and folded under the right hand side 33 of the material sheet 21, as indicated by the arrow B, as seen in the direction of feed, as indicated by the arrow C, of the assembled web of material sheets 21. Hence, the difference between the folding processes shown in FIGS. 3A and 3B respectively is the direction of the arrow B. The overlapping and folded material sheets 21 can then be fed as a continuous assembled web 34 towards a subsequent winding operation. FIG. 4B shows a side view of the continuous web 34 of material sheets according to the alternative embodiment of the invention, prior to the winding operation. As in FIG. 4A, the conveyor supporting the assembled web of material sheets has been removed for clarity. The assembled web of material sheets 21 are then attached to a mandrel 41 and subjected to a winding operation, as shown in FIG. 4B. The assembled, discrete material sheets 21 are wound in the clockwise direction, as indicated by the arrow D, to form a roll 42.

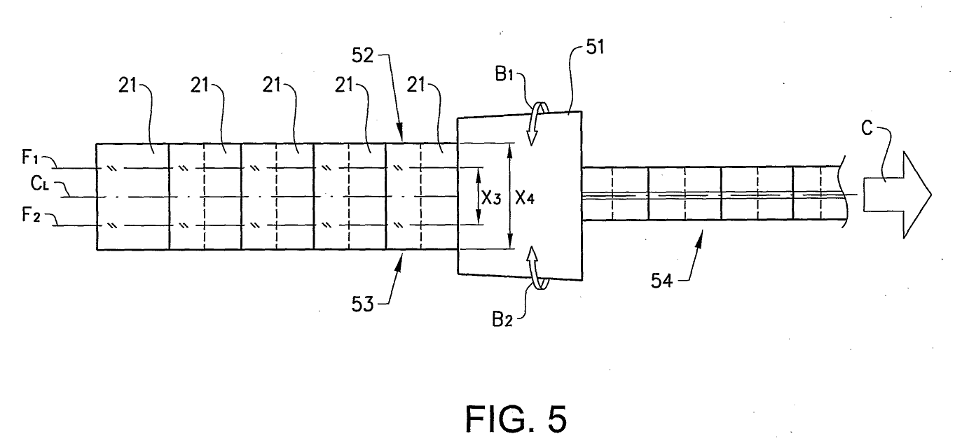

FIG. 5 shows an alternative longitudinal folding procedure, taking the place of the procedure described in FIGS. 3A and 3B. According to this alternative procedure, the material sheets are folded twice in the longitudinal direction of the said material sheets. The assembled web of overlapping material sheets 21 is fed through an apparatus 51 arranged to fold the sheets 21 along a first and a second fold line F₁, F₂, that are parallel to the longitudinal centreline C_{L} of the material sheets 21. In FIG. 5, the left hand side 52 of each material sheet is displaced upwards and folded along the first fold line F₁, as indicated by the arrow B₁, as seen in the direction of feed, as indicated by the arrow C, of the assembled web of material sheets 21. At the same time the right hand side 53 of each material sheet is displaced upwards and folded along the second fold line F₂, as indicated by the arrow B₂. Preferably, the distance X₃ between the parallel first and second fold lines F₁, F₂ is at least half the length X₄ of a material sheet in the transverse direction of the material sheets 21. In the schematic example shown, the first and second fold lines F₁, F₂ are placed symmetrically on both sides of the centreline with the distance X₃ being approximately 55% of the length X₄ of a material sheet. Alternatively, the same assembled web as shown in FIG. 4 can be used, wherein the folding is carried out in the opposite direction of the arrows B₁ and B₂, that is, downwards and inwards in the plan view shown. The assembled and folded material sheets 21 can then be fed as a continuous web 54 towards a subsequent winding operation. The winding operation has been described in connection with FIG. 4B above.

The first and second fold lines F₁, F₂ can also be placed asymmetrically relative to the longitudinal centreline C_{L} However, the distance X₃ between the parallel first and second fold lines F₁, F₂ should preferably not exceed half the length X₄ of a sheet. This type of folding arrangement is sometimes referred to as a C-fold and is preferably, but not necessarily, performed when the material sheets are placed in an overlapping relationship.

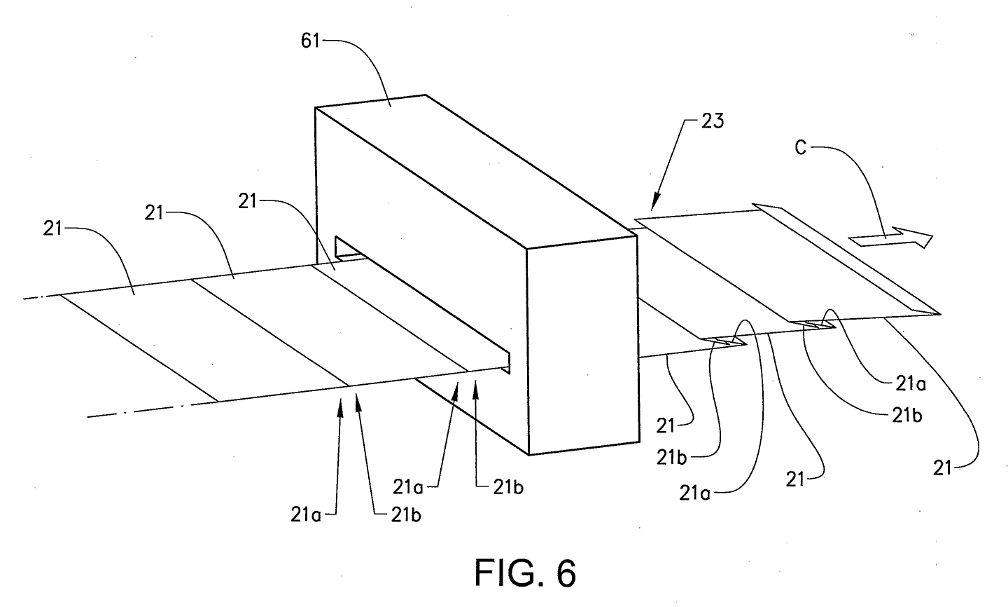

FIG. 6 shows a schematic perspective view of the first part of a process for making a roll of material sheets according to a second embodiment of the invention. As in the embodiment shown in FIG. 2, the material sheets used in the process have been pre-cut from a continuous web of material in a first step. The resulting material sheets have a longitudinal direction and a transverse direction. The process involves feeding an assembled web of discrete material sheets 21, placed end-to-end in their longitudinal direction, through an apparatus 61 arranged for folding the discrete material sheets 21 so that an overlap 23 is created by adjacent material sheets in their longitudinal direction.

According to this embodiment, the overlap is combined with an interlinking of the material sheets 21. Prior to being placed in an overlapping relationship, adjacent front and rear portions 21a, 21b of each respective sheet is folded once along a fold line arranged in the transverse direction of the respective material sheet. As shown in FIG. 6, the front portion 21a of each sheet is folded upwards and rearwards as seen in the direction of feed, as indicated by the arrow C, of the assembled web of material sheets 21. Similarly, the rear portion 21b of each sheet is folded downwards and forwards as seen in the direction of feed. The distance between a transverse edge of the sheet and an adjacent transverse fold line may be between 5-25% of the total length of an unfolded material sheet. In the example shown in FIG. 6 the distance between the transverse edge of each respective sheet and its adjacent transverse fold line is approximately 15% of the total length of a material sheet 21. As seen from the figure each material sheet 21 will be substantially Z-shaped and interlinked in such a way that each folded front portion 21a encloses the adjacent folded rear portion 21b. In this way, the front and rear portions 21a, 21b of adjacent material sheets 21 will be overlapping in that the folded front and rear portions of said sheets hook into each other. The Z-shape of the material sheets in FIG. 6 has been exaggerated for clarity. In fact, the assembled web of assembled and interlocking sheets would be substantially flat.

The above mentioned transverse folding is performed prior to a longitudinal folding step. The longitudinal folding step involves folding the sheets along a fold line coinciding with the longitudinal centreline of the material sheets, as described in connection with FIGS. 3A and 3B above.

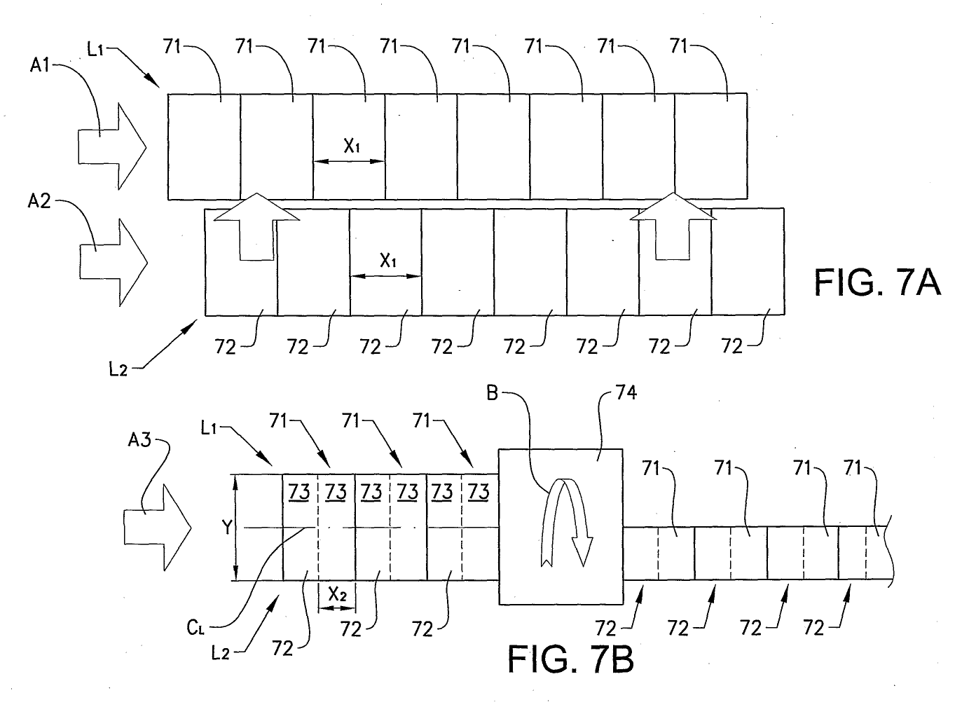

FIG. 7A shows a plan view of a first part of a process for making a roll of material sheets according to a first example of a second preferred embodiment of the invention. The process involves feeding two lines of individual material sheets in parallel, in the direction of the arrows A₁ and A₂, and placing on top of each other. This is achieved by cutting continuous webs of material (not shown) into a first line L₁ of sheets 71 and then placing a cut, second line L₂ of sheets 72 on top of said first line of sheets. In this example, the sheets 71, 72 of the respective first and second lines L₁, L₂ have the same length X₁ and are arranged end-to-end, with the material sheets 72 of the second line L₂ of sheets indexed to form an overlap 73 between subsequent sheets (FIG. 7B). The overlap 73 has a length X₂ corresponding to 50% of the length X₁ of a material sheet. Each alternate sheet of overlapping web is placed with its transverse rear portion arranged on top of a transverse front portion of a subsequent sheet, and with its transverse front portion on top of the transverse rear portion of a preceding sheet throughout the said web.

As can be seen in FIG. 7B, the first and second lines L₁, L₂ of sheets 71, 72 have been placed on top of each other with their respective side edges coinciding in a vertical plane, that is, with a 100% transverse overlap Y. The second part of the process involves feeding the lines L₁, L₂ of overlapping material sheets 71, 72 in the direction of the arrow A₃ through an apparatus 74 and folding it in half in the direction of the arrow B along a central fold line C_{L} into an assembled web. The assembled web can then be wound into a roll in the same way as the roll described in FIG. 4A or 4B above.

Alternatively, two lines of individual sheets arranged partially overlapping in the longitudinal direction as shown in FIG. 2 can be used. The folding can then be carried out in the direction of the arrow B as shown in FIG. 7B or in the opposite direction said arrow.

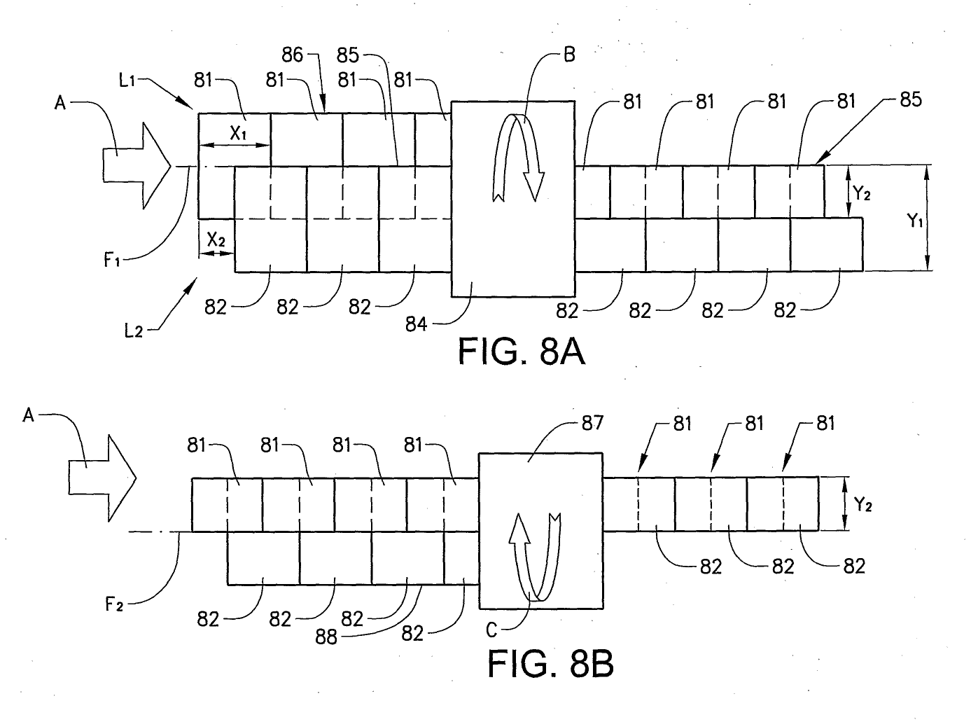

FIG. 8A shows a plan view of a first part of a process for making a roll of material sheets according to a second example of the second preferred embodiment of the invention. As in the first example, individual sheets 81, 82 of a respective first and second line L₁, L₂ are fed in the direction of the arrow A and are arranged end-to-end, with the material sheets 82 of the second line L₂ of sheets indexed to form an overlap of 50% between subsequent sheets in the longitudinal direction. The longitudinal overlap has a length X₂ that in this example is 50% of the longitudinal length X₁ of the material sheets. The transverse overlap Y₂ in this example is 50% of the transverse width Y₁ of the material sheets. The process involves feeding the lines L₁, L₂ of overlapping material sheets 81, 82 in the direction of the arrow A through a first apparatus 84 and folding it in the direction of the arrow B along a first fold line F₁. The first fold line F₁ coincides with the overlapping side edge 85 of the second line L2. During folding a first outer, non-overlapping edge 86 of the lower, first line L₁ of material sheets, which edge 86 is folded inwards over and fully covering the transverse overlap Y₂.

As shown in FIG. 8B, the web comprising partially overlapping and folded material sheets 81, 82 shown in FIG. 8A are fed in the direction of the arrow A through a second apparatus 87 and folding the web in the direction of the arrow C along a second fold line F₂. During folding a second outer, non-overlapping edge 88 of the upper, second line L₂ of material sheets is folded inwards over and fully covering the overlap Y₂. The assembled web can then be wound into a roll in the same way as the roll described in FIG. 4A or 4B above.

Alternatively the assembled web is created by simultaneously folding the outer edge of the lower line of material sheets upwards and inwards, and the outer edge of the upper line of material sheets downwards and inwards. Both folding arrangements create an assembled web comprising consecutive partially overlapping pairs of substantially V-shaped, opposed and interleaved material sheets.

The same effect, using partial overlap in the transverse direction may be achieved at other degrees of overlap. For instance, with a transverse overlap of ⅓ of the transverse width, the sheets on either side of the overlap may be folded in half towards to create an assembled web. Alternatively, with a transverse overlap of ⅔ of the transverse width, the sheets on either side of the overlap may be folded along a longitudinal fold line located at approximately ⅓ of the width from the outer edges of the respective of the first and second line of sheets to cover a part of the overlap and create an assembled web. The examples described above for the second preferred embodiment may also apply to examples using a variable overlap in the longitudinal direction.

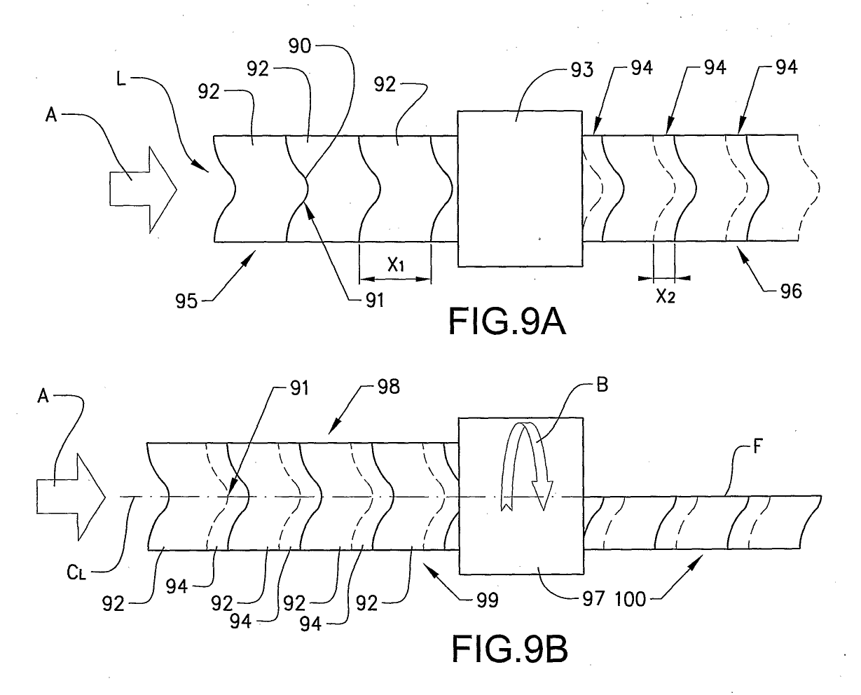

In the above embodiments, individual sheets in the line or lines of material sheets cut from a continuous web are separated by a straight, transverse cut at right angles to the longitudinal axis of the respective line of material sheets. FIG. 9A shows an alternative example, where a transverse cut 90 has the shape of a sinusoidal curve with an apex 91. The apex 91 forms a leading edge of each material sheet 92 in a line L of sheets. The process involves feeding a web of discrete material sheets 92, placed end-to-end in their longitudinal direction, through an apparatus 93 arranged for displacing the discrete material sheets 92 so that an overlap 94 is created by adjacent material sheets in their longitudinal direction. The direction of feed is indicated by the arrow A. This is achieved by controlling the relative speed of a first and a second conveyor 95, 96. The apparatus 93 for displacing the discrete material sheets 92 is provided with a device (not shown) for controlling the vertical position of the leading edge of a material sheet relative to the rear edge of a preceding sheet is provided at the location where the material sheets are passed from the first to the second conveyor. In the example shown, the length X₂ of the longitudinal overlap 94 is ⅓ of the length X₁ of a material sheet 92.

As shown in FIG. 9B, the apex 91 of the sinusoidal curve in FIG. 9A coincides with a fold line F and the sinusoidal curve is symmetrical about a central axis coinciding with the said fold line F in the plane of the material sheets. The web of overlapping material sheets 92 is fed through a second apparatus 97 arranged to fold the sheets 92 along a fold line F coinciding with the longitudinal centreline C_{L} of the material sheets 92, as shown in FIG. 9A. According to the example shown in FIG. 9B, the left hand side 98 of each material sheet is displaced upwards and folded over the right hand side 99 of the material sheet 92, as indicated by the arrow B, as seen in the direction of feed, as indicated by the arrow A, of the assembled web of material sheets 92. The overlapping and folded material sheets 92 can then be fed as a continuous assembled web 100 between opposing rollers and/or conveyors (not shown) and is subsequently subjected to a winding operation.

In the above embodiment, the apex is described as forming a leading edge. However, the apex can also form a trailing edge at the rearmost end of each material sheet in a line of sheets.

In addition to the overlap and folding described above, adjacent material sheets can be interlinked by one or more alternative arrangements in order to achieve a desired friction between contacting surfaces of said material sheets.

One alternative way of modifying the friction between overlapping sections of material sheet is the use of an embossing step performed on at least a portion of the overlap. According to one example the embossing is carried out by passing the assembled web of pre-cut and partially overlapping material sheets through a nip between a pair of cylindrical rolls. The rolls may be arranged to apply a desired amount of pressure onto at least a portion of the overlapping sections and/or to apply pressure over a predetermined surface area of each overlapping section. Alternatively, a pair of rolls can apply continuous pressure along the edges of the assembled web of sheets, allowing the said edges to be provided with a decorative pattern that provides enhanced friction in the region of each overlap. In the above examples, one or both rolls may be patterned in order to emboss the compressed portions to a predetermined degree.

Embossing or compression of selected portions of adjacent material sheets can be carried out after the overlapping procedure shown in FIG. 2, or after the folding procedures shown in FIG. 3A, 3B or 5, prior to the winding operation.

According to a further alternative way of modifying the friction, the material sheets can be interlinked by a friction enhancing coating applied onto at least a portion of the overlapping sections between adjacent sheets. A coating of this type is applied to at least a portion of one or both ends of each sheet in an assembled web of material sheets, prior to the sheets being displaced into their overlapping positions. The coating is applied by a single roller or a pair of rollers, or by spraying. Coatings of this type will modify the surface friction of at least one of the surfaces in an overlapping section. The coating preferably creates a brittle or crystalline bonding between contacting surfaces, which bond will break as a preceding material sheet is withdrawn from the dispenser.

According to a similar alternative way of modifying the friction, the material sheets can be interlinked by an adhesive on at least a portion of the overlap between adjacent sheets. Suitable adhesives include liquid, curable adhesives or hot-melt adhesives. Such adhesives are applied in the same way as the coatings described above. As stated above, the adhesive is applied prior to the sheets being displaced into their overlapping positions.

The invention is not limited to the above embodiments, but may be varied freely within the scope of the appended claims.

1-22. (canceled)

23. A roll of material sheets, which material sheets have a longitudinal direction and a transverse direction, the roll comprising discrete material sheets which partially overlap and are folded at least once in the longitudinal direction, which longitudinal direction corresponds to the winding direction of the roll, the material sheets being interlinked in such a way that, when a first material sheet is extracted, a predetermined part of a subsequent material sheet is fed out, and the material sheets are provided with an interlinking friction enhancing means placed in the overlap between adjacent material sheets.

24. The roll according to claim 23, wherein the material sheets are interlinked by an overlap of at least 25% of the length of an unfolded material sheet in its longitudinal direction.

25. The roll according to claim 24, wherein the material sheets are interlinked by an overlap of up to 50% of the length of an unfolded material sheet in the longitudinal direction.

26. The roll according to claim 23, wherein the material sheets are interlinked by an embossing on at least a portion of the overlap.

27. The roll according to claim 23, wherein the material sheets are interlinked by a friction enhancing coating on at least a portion of the overlap between adjacent sheets.

28. The roll according to claim 23, wherein the material sheets are interlinked by an adhesive on at least a portion of the overlap between adjacent sheets.

29. The roll according to claim 23, wherein the degree of overlap varies from the center of the roll to the outer periphery of the roll.

30. The roll according to claim 29, wherein the degree of overlap is at least 25% of the length of an unfolded material sheet in its longitudinal direction at the center of the roll and increases towards the outer periphery of the roll.

31. The roll according to claim 30, wherein the degree of overlap is up to 50% of the length of an unfolded material sheet in the longitudinal direction at the outer periphery of the roll.

32. The roll according to claim 23, wherein the material sheets are folded twice in the longitudinal direction, and the distance between the folds is at least half the width of a sheet in the transverse direction.

33. The roll according to claim 23, wherein opposing end portions of each sheet are folded once in opposite directions along a transverse fold line and adjacent sheets are interlinked in such a way that each folded end portion encloses the adjacent folded end portion.

34. The roll according to claim 23, wherein the partially overlapping material sheets comprise two parallel lines of individual material sheets placed on top of each other.

35. The roll according to claim 34, wherein each alternate sheet of overlapping material sheets is placed with its transverse rear portion arranged on top of a transverse front portion of a subsequent sheet.

36. The roll according to claim 35, wherein the material sheets are interlinked by a fixed or varying longitudinal overlap of at least 25% and up to 50% of the length of an unfolded material sheet in its longitudinal direction.

37. The roll according to claim 36, wherein the material sheets are interlinked by a transverse overlap selected between 30% and 100% of the transverse width of the material sheets.

38. The roll according to claim 23, wherein the material sheets are separated by a transverse cut having the shape of a curve having at least one apex, where the apex forms a leading or trailing edge of each material sheet in the line.

39. The roll according to claim 38, wherein the apex coincides with a fold line.

40. The roll according to claim 39, wherein the curve is symmetrical about an axis coinciding with the fold line in the plane of the material sheet.

41. The roll according to claim 23, wherein the roll is a center roll, whereby the material sheets are extracted from the center of the roll.

42. The roll according to claim 23, wherein the roll is a peripheral feed roll whereby the material sheets are extracted from the periphery of the roll.

43. The roll according to claim 23, wherein the material sheet is a tissue sheet, or a material sheet comprising a non-woven or equivalent wiping material.
